(19) United States
(12) Patent Application Publication
(10) Pub. No.: US 2010/0103948 A1
(43) Pub. Date: Apr. 29, 2010

(54) BACKUP TRANSMISSION STRUCTURE OF ELECTRONIC DEVICE

(76) Inventor: Tsung-Chun CHEN, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/256,785

(22) Filed: Oct. 23, 2008

(51) Int. Cl. H04L 12/40

(52) U.S. Cl. 370/438

(57) ABSTRACT

A backup transmission structure of an electronic device includes a switching unit, and primary and backup transmission circuits connected to host and terminal equipment respectively. The primary and backup transmission circuits include first and second switches respectively. The switching unit normally outputs an ON signal to the first switch to connect the primary transmission circuit for an electric connection of the host and terminal equipment. The primary transmission circuit obtains a circuit disable signal to switch outputting the ON signal to the second switch for electrically connecting the backup transmission circuit, so as to maintain an electric connection between the host equipment and the terminal equipment, and improve the stability of signal transmissions between the host equipment and the terminal equipment to overcome the shortcomings of the prior art adopting a host equipment that uses a single transmission circuit to connect terminal equipment in series and resulting in frequent breakdowns.

### FIELD OF THE INVENTION

The present invention relates to a backup transmission structure, and more particularly to a backup transmission structure applied in an electronic device for maintaining signal transmissions between host and terminal equipment.

### BACKGROUND OF THE INVENTION

As science and technology advance rapidly and various different electronic products such as computers, mobile phones and digital cameras are introduced to the market constantly, the function of a product is a major factor for consumers to select the product. To meet consumers' requirements, manufacturers keep adding functions to improve the add-on value of the products. These electronic products install a considerable number of electronic components to achieve multifunctional effect, and thus it is an important subject for manufacturers of the related industry to effectively integrate the electronic components into the electronic device to maintain a normal operation of the electronic device.

At present, most common electronic devices available in the market adopt a serial communication bus to connect host and terminal equipment in the electronic device. For instance, a motherboard of a computer device is connected to a hard disk drive, an optical disk drive, and input or output devices through an I²C bus or a RS-422 bus to achieve the electric connection, so that signals and commands can be transmitted between the motherboard and each device, or data can be accessed through the bus.

In the foregoing transmission structure of an electronic device as shown in FIG. 1, the electronic device comprises a host equipment 10 and a plurality of terminal equipment 20, and the electronic device further comprises a primary transmission circuit 30 for connecting the host equipment 10 and the terminal equipment 20, such that the host equipment 10 can be electrically connected to each terminal equipment 20 through the primary transmission circuit 30. Although the primary transmission circuit 30 can be used for transmitting signals or data, the host equipment 10 cannot transmit signals or data with other terminal equipment 20, or the electronic device may even be unable to operate normally, if any one of the terminal equipment 20 or the primary transmission circuit 30 in the electronic device is short-circuited or broken down. Furthermore, it is difficult to troubleshoot the failed terminal equipment 20 among so many terminal equipment 20 of the electronic device, and the prior art brings up the issue of difficult maintenance.

### SUMMARY OF THE INVENTION

The primary objective of the present invention is to overcome the foregoing shortcomings of the prior art by maintaining an electric connection between a host equipment and terminal equipment, so that the electronic device can be operated normally.

To achieve the foregoing objective, the present invention provides a backup transmission structure of an electronic device, and the transmission structure is electrically coupled to a host equipment and at least one terminal equipment in the electronic device, and includes at least two transmission circuits, namely a primary transmission circuit and a backup transmission circuit, electrically coupled to the host equipment and the terminal equipment. The primary transmission circuit and the backup transmission circuit include a first switch and a second switch thereon respectively, and the transmission structure further comprises a switching unit connected to the primary transmission circuit, the first switch and the second switch for normally outputting an ON signal to the first switch to connect the primary transmission circuit, so as to constitute an electric connection between the host equipment and the terminal equipment for signal transmissions. The switching unit obtains a circuit disable signal from the primary transmission circuit to switch outputting the ON signal to the second switch, so as to connect the backup transmission circuit and maintain an electric connection between the host equipment and the terminal equipment.

Compared with the prior art, the present invention improves the stability of a signal transmission between the host equipment and the terminal equipment.

### BRIEF DESCRIPTION OF THE DRAWINGS

FIG. 1 is a schematic view of a structure of a traditional communication system;

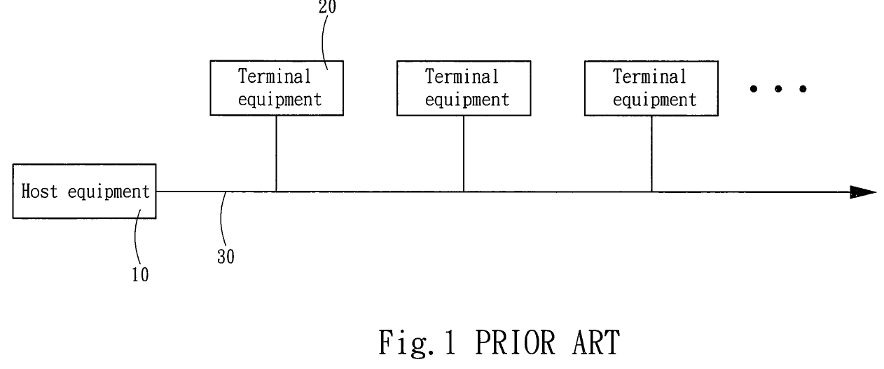

FIG. 2 is a schematic block diagram of the present invention; and

FIG. 3 is a schematic circuit diagram of the present invention.

### DETAILED DESCRIPTION OF THE PREFERRED EMBODIMENTS

The technical characteristics of the present invention will become apparent with the detailed description of preferred embodiments accompanied with related drawings as follows:

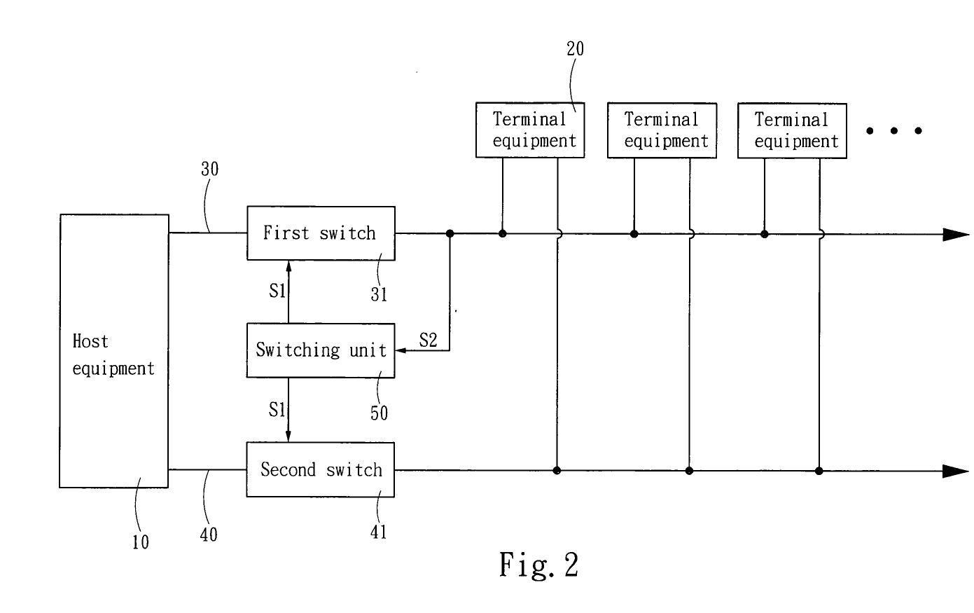

With reference to FIG. 2 for a backup transmission structure of an electronic device in accordance with the present invention, the transmission structure is electrically coupled to a host equipment 10 and at least one terminal equipment 20, and comprises at least two transmission circuits, namely a primary transmission circuit 30 and a backup transmission circuit 40 electrically coupled to the host equipment 10 and the terminal equipment 20. The primary transmission circuit 30 and the backup transmission circuit 40 include a first switch 31 and a second switch 41 thereon respectively. The transmission structure further comprises a switching unit 50 electrically coupled to the first switch 31 and the second switch 41 for normally outputting an ON signal S1 to the first switch 31 to connect the primary transmission circuit 30, such that the primary transmission circuit 30 constitutes an electric connection between the host equipment 10 and the terminal equipment 20. If the circuit connected between the host equipment 10 and the terminal equipment 20 is broken or no data is transmitted, the primary transmission circuit 30 will obtain a circuit disable signal S2, and the switching unit 50 will switch outputting the ON signal S1 to the second switch 41 to connect the backup transmission circuit 40, such that the host equipment 10 and the terminal equipment 20 are connected through the backup transmission circuit 40 for accessing or transmitting data. Therefore, the electric connection between the host equipment 10 and the terminal equipment 20 can be maintained.

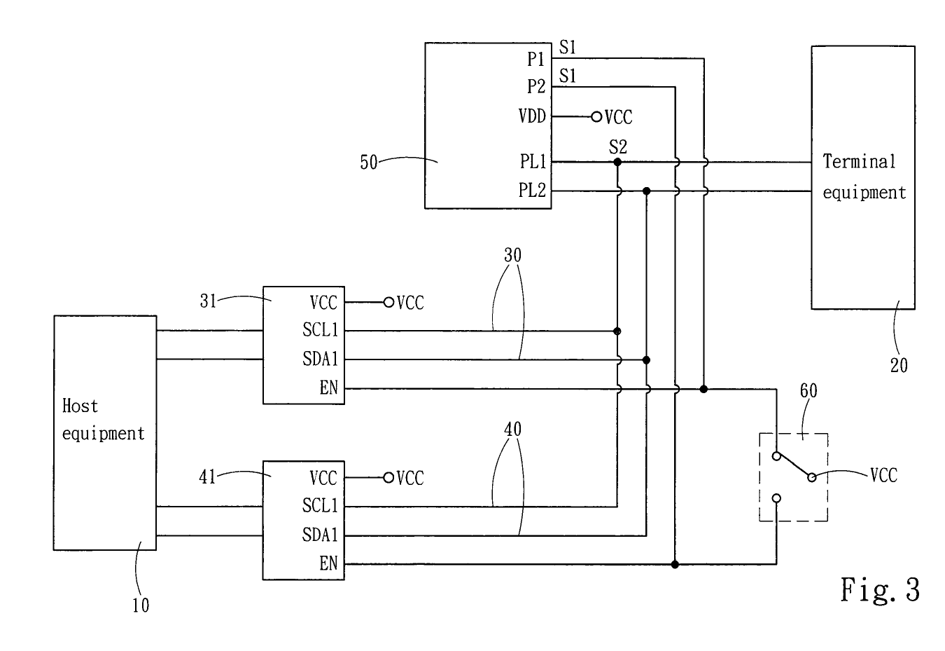

In a circuit structure of the present invention as shown in FIG. 3, the primary transmission circuit 30 and the backup transmission circuit 40 are serial communication buses which are inter-integrated circuit (I²C) buses, each including a serial data line (SDA) and a serial clock line (SCL). At the beginning, the switching unit 50 is set to output an ON signal S1 from a pin P1 to a pin EN of the first switch 31 to connect the primary transmission circuit 30, such that the host equipment 10 and the terminal equipment 20 can transmit data by the pins of the first switch 31 through the data lines (SDA, SCL). The switching unit 50 normally captures a data transmitted at the primary transmission circuit 30 between the host equipment 10 and the terminal equipment 20 through pins PL1, PL2 to determine the status of an electric connection at the primary transmission circuit 30 between the host equipment 10 and the terminal equipment 20. If the primary transmission circuit 30 or the terminal equipment 20 breaks down or has a short circuit, or no data is accessed between the host equipment 10 and the terminal equipment 20, the switching unit 50 will obtain the circuit disable signal S2 from the primary transmission circuit 30 through the pins PL1, PL2 to determine if the primary transmission circuit 30 is abnormal or disabled, and will stop outputting the ON signal S1 from the pin P1 to shut the first switch 31 and turn on the primary transmission circuit 30. Now, the switching unit 50 switches outputting the ON signal S1 to the second switch 41 through the pin P2, such that when the second switch 41 is connected, the backup transmission circuit 40 drives the host equipment 10 and the terminal equipment 20 to switch the data transmission from the backup transmission circuit 40 and electrically connect the host equipment 10 with the terminal equipment 20. Therefore, the invention can maintain a signal transmission and prevent the electronic device from being unable to operate normally when the primary transmission circuit 30 is broken down or short-circuited. The transmission structure further comprises an external switch 60 connected to the first switch 31 and the second switch 41, and provided for users to control the electric connection of the first switch 31 or the second switch 41 externally by the electronic device, so as to detect whether or not there is an abnormal condition of the primary transmission circuit 30 and the backup transmission circuit 40 and facilitate their repair and maintenance.

In summation of the description above, the present invention installs at least two transmission circuits (namely a primary transmission circuit 30 and a backup transmission circuit 40) between the host equipment 10 and the terminal equipment 20 for connecting the host equipment 10 and the terminal equipment 20 and uses a switching unit 50 for normally connecting the primary transmission circuit 30 and switching its connection to the backup transmission circuit 40, if the primary transmission circuit 30 is short-circuited or the host equipment 10 and the terminal equipment 20 have not been accessed for a long time, so as to maintain a signal transmission between the host equipment 10 and the terminal equipment 20.

Compared with the prior art, the present invention enhances the stability of a signal transmission between the host equipment 10 and the terminal equipment 20.

While the invention has been described by means of specific embodiments, numerous modifications and variations could be made thereto by those skilled in the art without departing from the scope and spirit of the invention set forth in the claims.

What is claimed is:

1. A backup transmission structure of an electronic device, and the transmission structure being electrically coupled to a host equipment and at least one terminal equipment in the electronic device, and comprising:
at least two transmission circuits including a primary transmission circuit and a backup transmission circuit electrically coupled to the host equipment and the terminal equipment, and the primary transmission circuit and the backup transmission circuit having a first switch and a second switch respectively;
a switching unit, for outputting an ON signal to the first switch to connect the primary transmission circuit, so as to constitute an electric connection between the host equipment and the terminal equipment, and the primary transmission circuit obtaining a circuit disable signal to switch outputting the ON signal to the second switch to connect the backup transmission circuit, so as to maintain the electric connection between the host equipment and the terminal equipment.

2. The backup transmission structure of an electronic device as recited in claim 1, wherein the primary transmission circuit is a serial communication bus.

3. The backup transmission structure of an electronic device as recited in claim 2, wherein the backup transmission circuit is a serial communication bus.

4. The backup transmission structure of an electronic device as recited in claim 1, wherein the backup transmission circuit is a serial communication bus.

5. The backup transmission structure of an electronic device as recited in claim 1, wherein the transmission structure further comprises an external switch connected to the first switch and the second switch.
